(19) United States
(12) Patent Application Publication
(10) Pub. No.: US 2008/0256350 A1
(43) Pub. Date: Oct. 16, 2008

(54) MOTHERBOARD, INFORMATION PROCESSOR, SETTING METHOD AND COMPUTER-READABLE RECORDING MEDIUM IN WHICH SETTING PROGRAM IS STORED

(75) Inventors: Taisuke HATTORI, Inagi (JP); Ichiro YAMAMOTO, Inagi (JP); Atsushi KOBAYASHI, Inagi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki-shi (JP); FUJITSU FRONTECH LIMITED, Tokyo (JP)

(21) Appl. No.: 12/021,695

(22) Filed: Jan. 29, 2008

(30) Foreign Application Priority Data
Jan. 30, 2007 (JP) 2007-019628

(51) Int. Cl. G06F 15/177

(52) U.S. Cl. 713/1

(57) ABSTRACT

A motherboard can be installed commonly in each of a plurality of electronic devices of various types different in configuration without modifying the BIOS setting by comprising a setting information retaining section retaining setting information for a setting process for each electronic device; a specification information obtaining section obtaining specification information for specifying the type of each electronic device; a modifying information retaining section retaining modification information for modifying the setting information according to the type of each electronic device; a setting information modifying section modifying, on the basis of the specification information and the modification information retained, the setting information according to the type of the device in which the motherboard is installed; and a setting process performing section for performing the setting process for the device on the basis of the modified setting information.

### BACKGROUND OF THE INVENTION

1. Field of the Invention

The present invention relates to a method of setting an information processor, such as a Point-Of-Sales (POS) terminal, when turned on, and more particularly to a setting method preferably used when a motherboard that can be used commonly in information processors of various types differing configuration is being installed in different types of information processors.

2. Description of the Related Art

In general, when designing and manufacturing of POS terminals used in POS (Point Of Sales) systems, common parts are sometimes used for a number of different types of terminals, with the intention of reducing in manufacturing costs. For example, Patent Reference 1 below discloses a technique to reduce manufacturing costs and facilitate an assembly operation by commonly using the same parts in commodity data processing machines of different types.

An ordinary POS terminal has a structure to detachably accommodate a motherboard on which a processor or the like is mounted, and such a motherboard is sometimes used in POS terminals of different types.

[Patent Reference 1] Japanese Patent Application Laid-Open (KOKAI) No. HEI 2006-155515

However, in order to commonly use the same motherboard in different-type machines, the Basic Input/Output System (BIOS) setting in a motherboard may have to be modified according to the system of a machine in which the motherboard is to be installed.

FIGS. 14-16 are diagrams illustrating a perspective view of an appearance of a POS terminal; FIG. 14 shows a perspective view of an integral-type POS terminal 201a and FIGS. 15 and 16 show perspective views of a separated-type POS terminal 201b. In addition, FIG. 15 shows the separated-type POS terminal 201b seen from the display side, and FIG. 16 shows the same separated-type POS terminal 201b seen from the opposite side of FIG. 15.

POS terminal 201a shown in FIG. 14 includes motherboard 202, power-source unit 203, cooling fan 205 and temperature sensor 204, and takes the form of an integral type in which power-source unit 203 and motherboard 202 are installed in the same case 206.

Temperature sensor 204 measures the temperature of CPU 11 (not illustrated) mounted on motherboard 202, and cooling fan 205 exhausts air from and draws air into the apparatus to cool the motherboard 202 including the CPU and inside the case including the power-source unit 203.

In POS terminal 201a, temperature sensor 204 mounted on motherboard 202 or the like measures the temperature of CPU 11 and controls cooling fan 205 on the basis of a measurement result by temperature sensor 204, and the temperature of CPU 11 is controlled so as not to exceed a predetermined temperature.

POS terminal 201a causes cooling fan 205 to rotate at a high speed when the CPU is at high temperature in order to cool the CPU.

POS terminal 201b shown in FIGS. 15 and 16 is different in configuration from POS terminal 201a, and is formed by coupling two cases of first case 206-1 and second case 206-2. POS terminal 201b includes motherboard 202, power-source unit 203, cooling fan 205-1 and 205-2, temperature sensors 204-1 and 204-2. Power-source unit 203 and cooling fan 205-1 are incorporated in first case 206-1, and motherboard 202 and cooling fan 205-2 are incorporated in second case 206-2.

In POS terminal 201b, temperature sensor 204-1 mounted on power-source unit 203 or the like measures the temperature of the inside power-source unit 203 and cooling fan 205-1 is controlled on the basis of the measurement result obtained by temperature sensor 204-1. Concurrently temperature sensor 204-2 mounted on motherboard 202 or the like measures CPU temperature and cooling fan 205-2 is controlled on the basis of a measurement result by temperature sensor 204-2. Consequently, cooling fans are controlled so that the temperatures of the CPU and power-source unit 203 do not exceed predetermined temperatures.

If temperature sensor 204-1 detects a high temperature of power-source unit 203, POS terminal 201b rotates cooling fan 205-1 at high speed to cool power-source unit 203. If temperature sensor 204-2 detects a high CPU temperature, cooling fan 205-2 being rotated at high speed cools the CPU.

Since POS terminals 201a and 201b are different in hardware configuration, the BIOS settings of these terminals are also different from each other. For example, if the CPU of POS terminal 201b is at high temperature, cooling fan 205-1 rotating at a high speed does not lower the temperature of the CPU but, may increase noise.

Accordingly, when a conventional motherboard 202 common to POS terminals of various types is to be installed in POS terminal, the BIOS setting of motherboard 202 after being installed in the terminal is modified according to the system configuration of the POS terminal. The system configuration is exemplified by a manner of controlling rotation speed of the cooling fan. A complex operation to modify the BIOS setting is required and consequently incurs additional costs.

Further, an operator may make a setting error due to an operation mistake during modification on the BIOS setting. Such a setting error causes the POS terminal not to work correctly.

Such a setting error by an operator can be effectively avoided by human procedure manuals, which however require considerable complicated labor to be created for each system configuration of POS terminals. In addition, management of generated documents is also a laborious task.

In general management of a conventional motherboard common to POS terminals of various types, the same motherboards are regarded as different motherboards by allocating different numbers to different BIOS settings, to which different numbers are allocated for each of different BIOS settings. Manufacturing and maintenance need to prepare motherboards of all the numbers and that problematically increases the management procedures and maintenance costs for parts of the motherboards.

### SUMMARY OF THE INVENTION

With the foregoing problems in view, the object of the present invention is to install a motherboard that is common to different-type machines in one of the machines without an operator setting the BIOS setting according to the type of the machine.

To attain the above object, as a first characteristic feature, there is provided a motherboard capable of being installed in each of a plurality of electronic devices of various types different in configuration comprising: a setting information retaining section retaining setting information that is to be used in a setting process for each of the plurality of electronic devices; a specification information obtaining section obtaining specification information that is to be used for specifying the type of the electronic device; a modifying information retaining section retaining modification information that is to be used for modifying the setting information according to the type of the electronic device; a setting information modifying section modifying, on the basis of the specification information obtained by the specification information obtaining section and the modification information retained in the modifying information retaining section, the setting information retained in the setting information retaining section according to the type of the electronic device in which the motherboard is installed; and a setting process performing section for performing the setting process for one of the plurality of electronic devices in which the motherboard is installed on the basis of the setting information modified by setting information modifying section.

As a preferable feature, the electronic device may include a specification information retaining section retaining the specification information; and the specification information obtaining section may obtain the specification information from the one electronic device in a state in which the mother board is installed.

As another preferable feature, the motherboard may further comprise a specification information retaining section retaining the specification information, and the specification information obtaining section may obtain the specification information from the specification information retaining section.

As an additional preferable feature, the motherboard may further comprise a setting section setting whether or not the setting information modifying section is to modify the setting information, and the setting information modifying section may modify the setting information only when the result of setting by the setting section is positive.

As a further preferable feature, the setting section may set whether or not the setting information modifying section is to perform the modifying for each item of the setting information.

As a second generic feature, there is provided an information processor including a main unit and a motherboard, which is capable of being installed in the main unit and which is capable of being installed in a main unit of an information processor of another type different in configuration from the first information processor, comprising: a specification information retaining section retaining specification information that is to be used for specifying the type of the first information processor; a setting information retaining section retaining setting information that is used in a setting process for the first information processor; a specification information obtaining section obtaining the specification information from the specification information retaining section in a state in which the motherboard is installed in the main unit of the first information processor; a modifying information retaining section retaining modification information that is to be used for modifying the setting information according to the type of the electronic device; a setting information modifying section modifying, on the basis of the specification information obtained by the specification information obtaining section and the modification information retained in the modifying information retaining section, the setting information retained in the setting information retaining section according to the type of the first information processor in which the motherboard is installed; and a setting process performing section for setting the setting process for the first information processor on the basis of the setting information modified by setting information modifying section, wherein the motherboard includes the setting information retaining section, the specification information obtaining section, the modification information retaining section, the setting information modifying section and the setting process performing section.

As a preferable feature, the main unit of the first processor may include the specification information retaining section. As another preferable feature, the specification information obtaining section may obtain the specification information from the main unit of the first processor in a state in which the motherboard is installed in the main unit.

As an additional preferable feature, the motherboard may include the specification information retaining section. As a further preferable feature, the specification information obtaining section may obtain the specification information from the specification information retaining section.

As a still further preferable feature, the first information processor may further comprise a setting section setting whether or not the setting information modifying section is to modify the setting information and the setting information modifying section may modify the setting information only when the result of setting by the setting section is positive.

As a still further preferable feature, the setting section may set whether or not the setting information modifying section is to perform the modifying for each item of the setting information.

As a third generic feature, there is provided a method for setting an information processor including a main unit and a motherboard, which is capable of being installed in the main unit and which is capable of being installed in main units of a number of second information processors of various types different in configuration from the first information processor, comprising the steps of: obtaining specification information that is to be used for specifying the type of the first information processor; modifying, on the basis of the specification information obtained in the step of obtaining and modification information used for modifying setting information used in a setting process for setting the first information processor according to the type of the first information processor which setting information is retained in a setting information retaining section, the setting information according to the type of the first information processor in which the motherboard is installed; and performing the setting process on the first information processor using the setting information modified in the step of modifying.

As a preferable feature, the method may further comprise the step of confirming whether or not the setting information is to be modified in the step of modifying, wherein the setting information may be modified in the step of modifying only when the result of the confirming in the step of confirming is positive.

As another preferable feature, in the step of setting, whether or not the modifying in the step of modifying is to be performed is set for each item of the setting information.

As a fourth generic feature, there is provided a computer-readable recording medium in which a setting program for setting a computer including a main unit and a motherboard, which is capable of being installed in the main unit and which is capable of being installed in a number of computers of various types different in configuration from the first computer is recorded, wherein the setting program instructs the first computer to execute the following steps of: obtaining specification information that is to be used for specifying the type of the first computer; modifying, on the basis of the specification information obtained in the step of obtaining and modification information used for modifying setting information used in a setting process for the first computer according to the type of the first computer which setting information is retained in a setting information retaining section, the setting information according to the type of the first computer in which the motherboard is installed; and performing the setting process on the first computer using the setting information modified in the step of modifying.

As a preferable feature, the setting program may further instruct the first computer to execute the step of confirming whether or not the setting information is to be modified in the step of modifying; and the modifying of the setting information in the step of modifying may be performed only when the result of the confirming in the step of confirming is positive.

As another preferable feature, in the step of setting, whether or not the modifying in the step of modifying is to be performed may be set for each item of the setting information.

The present invention guarantees at least one of the advantages below.

(1) Automatic modification of the setting information according to the type of an information processor in which the motherboard is installed on the basis of the specification information, the modification information requiring no operator labor to set the information processor and thereby reducing the process quantity. This is economical and convenient, and helps to avoid the occurrence of human setting error. It is consequently possible to provide an information processor with high reliability in which system malfunctioning is prohibited.

(2) Since the motherboard, without being modified, can be (commonly) used in a number of information processors of various types differing in hardware and/or software configurations even if the BIOS settings of the information processors are different from one another, management labor and the maintenance costs for parts of motherboard can be reduced, and the motherboard becomes economical and convenient.

(3) Since the same motherboards can easily be used in a number of different information processors (i.e. of various different types), improvement in usage of the same materials and parts in such different information processors can further enhance economy.

(4) The setting information is modified only when the setting information is set to be modified. That makes it possible to arbitrarily set whether or not the setting information is modified, which is therefore high in flexibility.

(5) Since whether or not the setting information is modified for each item of the setting information can be set, such setting provides high flexibility and high convenience.

Other objects and further features of the present invention will be apparent from the following detailed description when read in conjunction with the accompanying drawings.

### BRIEF DESCRIPTION OF THE DRAWINGS

FIG. 1 is a block diagram schematically showing the configuration of a POS terminal equipped with a motherboard according to a first embodiment of the present invention;

FIG. 2 is a perspective view illustrating an appearance of a POS terminal;

FIG. 3 is a perspective view illustrating an appearance of a POS terminal;

FIG. 4 is a perspective view illustrating an appearance of a POS terminal;

FIG. 5 is a diagram schematically showing a configuration of an individual ID setting section in a POS terminal in which a motherboard according to the first embodiment is installed;

FIG. 6 is a diagram schematically showing a configuration of an individual ID setting section in a POS terminal in which a motherboard according to the first embodiment is installed;

FIG. 7 is a flow diagram showing a succession of procedural steps performed when activation of a POS terminal in which a motherboard according to the first embodiment is installed;

FIG. 8 is a block diagram showing a POS terminal equipped with a motherboard according to a modification of the first embodiment;

FIG. 9 is a table showing an example of CMOS setting information concerning the boot display of a POS terminal in which a motherboard according to the modification is installed;

FIG. 10 is a diagram showing an example of the structure of modification information for a POS terminal in which a motherboard according to the modification is installed;

FIG. 11 is a diagram showing an example of modification information for a POS terminal in which a motherboard according to the modification is installed;

FIG. 12 is a flow diagram showing a succession of procedural steps performed when activation of a POS terminal in which a motherboard according to the modification is installed;

FIGS. 13(a), 13(b), 13(c), and 13(d) are diagrams showing other examples of the individual ID setting section of a POS terminal in which the motherboard according to the first embodiment is installed;

FIG. 14 is a perspective view illustrating an appearance of a POS terminal;

FIG. 15 is a perspective view illustrating an appearance of a POS terminal; and

FIG. 16 is a perspective view illustrating an appearance of a POS terminal;

### DESCRIPTION OF THE PREFERRED EMBODIMENTS

A preferred embodiment of the present invention will now be described with reference to the accompanying drawings.

### (A) First Embodiment

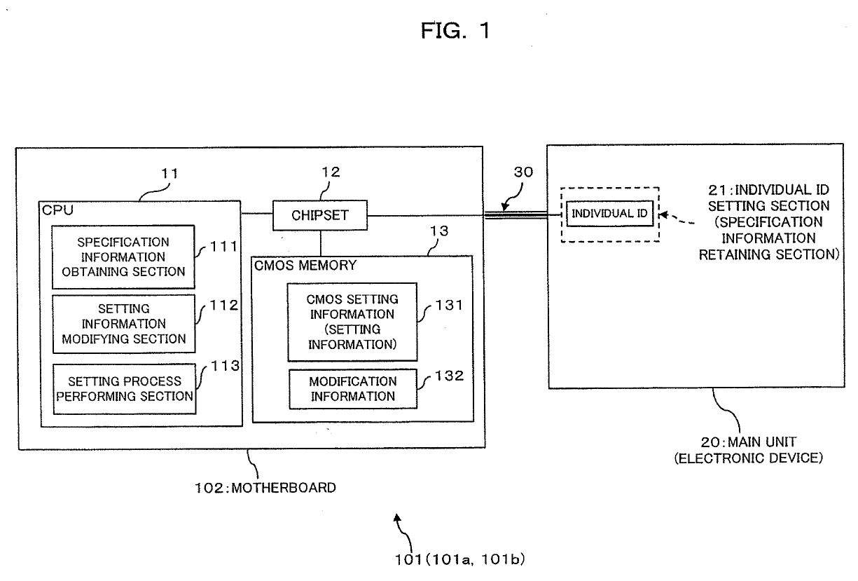

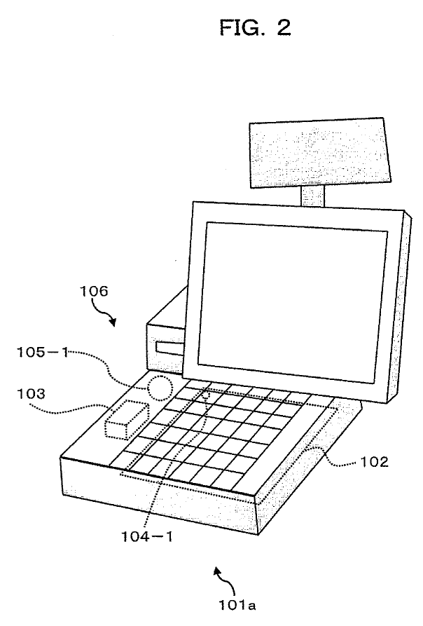

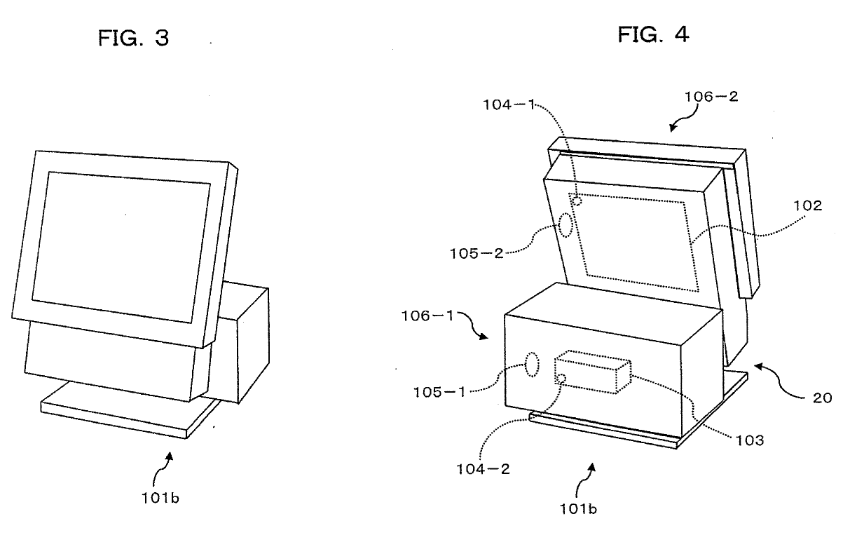

FIG. 1 is a block diagram schematically showing the configuration of a POS terminal (an information processor, an electronic device) in which a motherboard according to the first embodiment is installed. FIGS. 2-4 are diagrams each showing a perspective view of an appearance of a POS terminal; FIG. 2 shows a perspective view of an integral-type POS terminal and FIGS. 3 and 4 show perspective views of a separated-type POS terminal. In addition, FIG. 3 shows the separated-type POS terminal seen from the display side, and FIG. 4 sees the same separated-type POS terminal 101b seen from the opposite side of FIG. 3.

Motherboard 102 according to the first embodiment is an electronic component installed in POS (Point Of Sales) terminal 101a or 101b of a POS system which terminal is placed in a retail store or the like. Motherboard 102 can be installed in each of POS terminal 101a (see FIG. 2) and POS terminal 102b (see FIGS. 3 and 4) that are different in configuration (type). In other words, motherboard 102 is common to POS terminal 101a and POS terminal 101b, and can be installed in POS terminals 101a and 102 of various types (two types in the illustrated example).

Motherboard 102 includes, as shown in FIG. 1, CPU 11, chipset 12, and CMOS memory 13. Execution of programs and OS (Operating System) stored in CMOS memory 13 or other storage devices (not shown) by CPU 11 causes corresponding POS terminal 101a or 101b to realize various functions.

Here, POS terminal 101a shown in FIG. 2 includes motherboard 102, power-source unit 103, power-source fan 105-1 and temperature sensor 104-1, and takes the form of an integral type in which power-source unit 103 and motherboard 102 are installed in the same case 106.

In POS terminal 101a, temperature sensor 104-1 measures the temperature near CPU 11 (see FIG. 1) mounted on motherboard 102; and power-source fan 105-1 includes a motor and a fan (both not shown) and exhausts air from and draws air into the apparatus by rotation of the fan driven by the motor, so that the apparatus including the CPU and the power source is cooled.

Power-source fan 105-1 controls the rotation speed of the motor under the control of CPU 11, and specifically controls the rotation speed of the motor of power-source fan 105-1 on the basis of a detection result by temperature sensor 104-1 by setting a function for controlling a power-source fan rotation speed to “valid” by the BIOS (Basic Input Output System) program at the time when turning on POS terminal 101a or the like. The function for controlling a power-source fan rotation speed carries out control such that, for example, power-source fan 105-1 rotates at a high speed when CPU 11 is high in temperature.

In POS terminal 101a, temperature sensor 104-1 measures the temperature near CPU 11 mounted on motherboard 102 and controls power-source fan 105-1 on the basis of the measurement result by temperature sensor 104-1, so that the temperature of CPU 11 is controlled so as not to exceed a predetermined temperature.

In the POS terminal 101a, a control of the rotation speed of the motor of power-source fan 105-1 controls the rotation speed of the power-source fan that cools CPU 11. For example, when CPU 11 is at a high temperature, CPU 11 is cooled by power-source fan 105-1 rotating at a high speed.

POS terminal 101b shown in FIGS. 3 and 4 is different in configuration from POS terminal 101a, and is formed by coupling first case 106-1 and second case 106-2. POS terminal 101b includes motherboard 102, power-source unit 103, power-source fan 105-1, CPU fan 105-2, and temperature sensors 104-1 and 104-2. Power-source unit 103, temperature sensor 104-2, and power-source fan 105-1 are incorporated in first case 106-1, and motherboard 102, temperature sensor 104-1, and CPU fan 105-2 are incorporated in second case 106-2.

Like reference numbers designate similar parts or elements throughout several views of different illustrated examples, so any repetitious description is omitted here.

Temperature sensor 104-1 measures the temperature near CPU 11 mounted on motherboard 102, and temperature sensor 104-2 measures the temperature of the inside of power-source unit 103. Power-source fan 105-1 draws air into power-source unit 103 by the fan being rotationally driven by the motor and thereby cools power-source unit 103. CPU fan 105-2 includes a motor and a fan (which are not shown) and draws air into CPU 11 by the fan being rotationally driven by the motor to cool CPU 11.

Power-source fan 105-1 and CPU fan 105-2 control the rotation speeds of the respective motors under the control of CPU 11.

In POS terminal 101b, since CPU 11 and power-source unit 103 are incorporated in different cases, the function for controlling a power-source fan rotation speed that controls power-source fan 105-1 according to the temperature of CPU 11 is set to be invalid.

Further, in POS terminal 101b, temperature sensor 104-1 measures the temperature near to CPU 11 mounted on motherboard 102 and CPU fan 105-2 is controlled on the basis of the measurement result by temperature sensor 104-1 so as to cool CPU 11. Temperature sensor 104-2 measures the temperature of the inside of the power-source unit 103 and power-source fan 105-1 is controlled on the basis of the measurement result by temperature sensor 104-2 so as to cool power-source unit 103.

Hereinafter, individual POS terminals are specified by reference numbers 101a and 101b as required, but an arbitrary POS terminal is represented by reference number 101.

As shown in FIG. 1, POS terminal 101 is formed by communicably coupling motherboard 102 and main unit 20 via connector 30. Main unit 20 includes individual ID setting section (specification information retaining section) 21. In the first embodiment, each of POS terminals 101a and 101b includes individual ID setting section 21, which sets and retains an individual ID (specification information) corresponding to the type of POS terminal 101.

This embodiment uses POS terminals 101 of two types: an integral-type (POS terminal 101a) and a separated-type (POS terminal 101b). Specification information of “individual ID=0” and that of “individual ID=1” are previously determined for integral-type POS terminal 101a and separated-type POS terminal 101b, respectively. Such individual IDs make it possible to specify the two types of POS terminals.

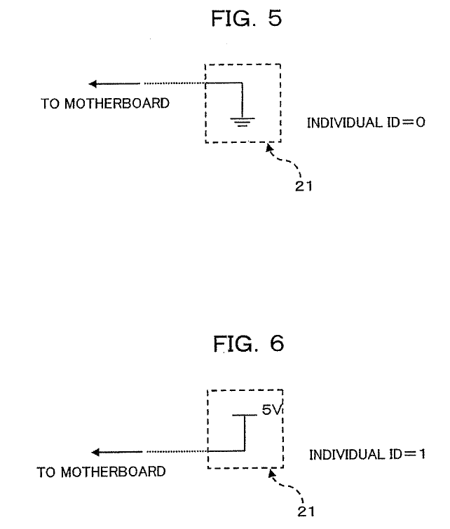

FIGS. 5 and 6 schematically show configurations of individual ID setting section 21 for POS terminal 101 incorporating motherboard 102 according to the first embodiment: FIG. 5 shows a configuration of individual ID setting section 21 incorporated in main unit 20 of integral-type POS terminal 101a with individual ID=0 and FIG. 6 shows a configuration of individual ID setting section 21 incorporated in main unit 20 of separated-type POS terminal 101b with individual ID=1.

Individual ID setting section 21 shown in FIG. 5 has a terminal grounded and thereby retains “0 (LO)” as an individual ID and that shown in FIG. 6 has a terminal connected to a power source (a 5V power source in the example of FIG. 6) and thereby retains “1 (HI)” as an individual ID.

In other words, individual ID setting section 21 takes the form of an individual ID fixed to a print board.

Connector 30 communicably connects motherboard 102 to main unit 20, and is exemplified by a GPIO (General Purpose Input Output) interface.

The individual ID set in individual ID setting section 21 of main unit 20 is obtained by CPU 11 (specification information obtaining section 111) through chipset 12 to be detailed below.

CMOS (Complementary Metal Oxide Semiconductor) memory 13 is a nonvolatile memory to readably retain various programs and data, and stores CMOS setting information (setting information) 131 and modification information 132 in predetermined regions thereof.

CMOS setting information 131 is setting information (BIOS setting information) used when the BIOS program activates POS terminal 101, and is formed by various BIOS setting items each associated with a setting value, for example.

CMOS memory 13 functions as a setting information retaining section for retaining setting information used in a setting process for POS terminal 101.

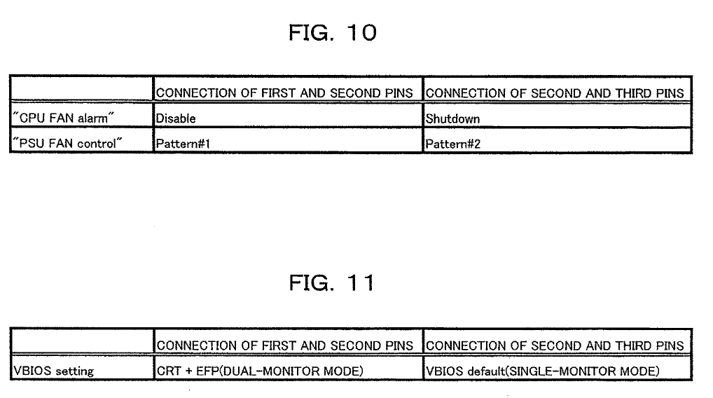

Modification information 132 is used to modify CMOS setting information 131 according to the type of POS terminal 101, and is formed by, for example, associating one or more of the BIOS setting items in CMOS setting information 131 that have to be modified according to the type of POS terminal 101 and information of the one or more BIOS setting items after the modification with information (e.g., an individual ID) to specify the type of POS terminal 101 (see FIGS. 10 and 11).

In other words, modification information 132 is formed by associating at least BIOS setting items that vary with types of POS terminals 101 with the type of POS terminal 101 and setting the setting values (after the modification) of the BIOS setting items.

For example, since POS terminal 101a and POS terminal 101b differ in the function for controlling a power-source fan rotation speed as described above, modification information 132 is information that makes the function for controlling the power-source rotational speed for POS terminal 101a (with individual ID=1) “valid” and makes the same function for POS terminal 101b (with individual ID=0) “invalid”. The function for controlling a power-source fan rotation speed controls the rotational speed of the power-source fan in accordance with the temperature of the CPU. In POS terminal 101b, the rotation speed of the power-source fan is controlled in terms of the temperature of the power source.

Modification information 132 exemplified by the above information can be stored in any format known to the public.

CMOS memory 13 therefore functions as a modification information retaining section for retaining modification used for modifying setting information according to the type of POS terminal 101.

CPU 11 executes programs and an OS read from a storage unit such as a ROM, a RAM or HDD (that are not shown) to instruct POS terminal 101 to realize various functions. When POS terminal 101 is being activated, CPU 11 executes the BIOS program (setting program) to thereby function as specification information obtaining section 111, setting information modifying section 112, and setting process performing section 113.

The BIOS program determines (sets) various settings of POS terminal 101, and is generally stored in a dedicated region in a BIOS ROM or a nonvolatile memory.

The BIOS program (setting program) to realize the functions as specification information obtaining section 111, setting information modifying section 112, and setting process performing section 113 may be provided in the form of being stored in a computer-readable recording medium, such as a flexible disk, a CD (e.g., CD-ROM, CD-R, CD-RW), a DVD (e.g., DVD-ROM, DVD-RAM, DVD+R, DVD-R, DVD+RW, DVD-RW), a magnetic disk, an optical disk, or a magneto-optical disk. Further, POS terminal 101 (an information processor, a computer) reads the program from the recording medium and sends the read program to an internal memory such as a BIOS memory to store for later use. Further alternatively, the BIOS program may be recorded in a memory device (a recording medium), such as a magnetic disk, an optical disk or a magneto-optical disk, and is provided to the computer from the memory device through a communication path.

In order to realize the functions as specification information obtaining section 111, setting information modifying section 112, and setting process performing section 113, the BIOS program stored in an internal memory (e.g., a BIOS ROM or a nonvolatile memory) is executed by a microprocessor (CPU 11 in this embodiment) of the computer.

Here, a computer is a concept of a combination of hardware and an OS, and means hardware which operates under control of the OS. Otherwise, if an application program operates hardware independently of an OS, the hardware itself corresponds to the computer. Hardware includes at least a microprocessor such as CPU 11 and means to read the BIOS program (a computer program) recorded in a memory device. In the first embodiment, POS terminal 101 serves to function as a computer.

The recording medium used in the first embodiment may be various computer-readable recording media such as an IC card, a ROM cartridge, a magnetic tape, a punch card, an internal storage unit (RAM or ROM) for a computer, an external storage unit, or a printed matter on which codes, such as bar codes, are printed, in addition to a flexible disk, a CD (e.g., CD-ROM, CD-R, CD-RW), a DVD (e.g., DVD-ROM, DVD-RAM, DVD-R, DVD+R, DVD-RW, DVD+RW), a magnetic disk, an optical disk and a magnet-optical disk above listed.

Specification information obtaining section 111 in a state of being installed in main unit 20 obtains an individual ID, with which the type of the POS terminal 101 can be specified, from the main unit 20 and specifically obtains the individual ID set in individual ID setting section 21 of the main unit 20.

More specifically, specification information obtaining section 111 obtains an individual ID through connector 30 by using a function possessed by chipset 12 such as GPIO. Information set in main unit 20 can be obtained by the function of chipset 12 in any method already known to the public, explanation of which is however omitted here.

Setting information modifying section 112 automatically modifies CMOS setting information 131 recorded in CMOS memory 13 in accordance with the type of POS terminal 101 in which the motherboard 102 in question is installed on the basis of the individual ID obtained by specification information obtaining section 111 and modification information 132 retained in CMOS memory 13.

Specifically, setting information modifying section 112 consults modification information 132 stored in CMOS memory 13 and modifies (rewrites) at least part of the BIOS setting items in CMOS setting information 131 in accordance with the type of POS terminal 101.

CMOS setting information 131 modified by setting information modifying section 112 may be stored (overwrite-saved) in CMOS memory 13 or may be discarded after being used by the BIOS program. Otherwise, various alternations can be suggested.

Setting process performing section 113 sets various settings for hardware and software used in POS terminal 101 on the basis of CMOS setting information 131. In detail, on the basis of CMOS setting information 131 modified by setting information modifying section 112, setting process performing section 113 performs a setting process for POS terminal 101.

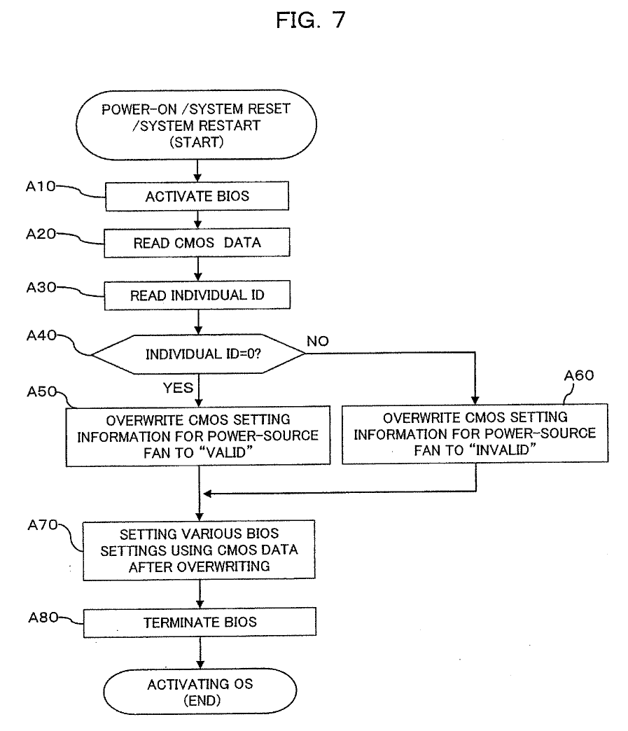

Description will be made in relation to the succession of procedural steps performed in POS terminal 101 incorporating motherboard 102 according to the first embodiment with reference to flow diagram FIG. 7 (steps A10-A80).

When POS terminal 101 undergoes powering-on, system reset or system restart, the BIOS program is executed and activated (step A10) and various data pieces (CMOS data) required for activation of POS terminal 101 are read from CMOS memory 13 (step A20).

In succession, specification information obtaining section 111 obtains (reads) the individual ID from individual ID setting section 21 disposed in main unit 20 (step A30, the specification information obtaining step), and confirms the individual ID (step A40).

Here, since individual ID being “0” (Yes route in step A40) indicates that motherboard 102 in question is installed in POS terminal 101a, setting information modifying section 112 obtains CMOS setting information 131 (CMOS data) and consults modification information 132 stored in CMOS memory 13 to overwrite the f function for controlling a power-source fan rotation speed in CMOS setting information 131 to “valid” (step A50, the setting information modification step).

After that, setting process performing section 113 sets various settings of the BIOS function using CMOS setting information 101 modified by setting information modifying section 112 (step A70, the setting process performing step).

Conversely, since individual ID being “1” (NO route in step A40) indicates that motherboard 102 in question is installed in POS terminal 101b, setting information modifying section 112 obtains CMOS setting information 131 (CMOS data) and consults modification information 132 stored in CMOS memory 13 to overwrite the function for controlling a power-source fan rotation speed in the BIOS setting information to “invalid” (step A60, the setting information modification step) and then the procedure moves to step A70.

After completion of the process performed by the BIOS program (step A80), activation of the OS and various programs terminates the activation process and various functions of POS terminal 101 are then realized.

In POS terminal 101 incorporating motherboard 102 according to the first embodiment, setting information modifying section 112 automatically modifies CMOS setting information 131 according to the type of POS terminal 101 on the basis of the individual ID obtained by specification information obtaining section 111 and modification information 132 stored in CMOS memory 13, as described above. That requires no operation by an operator to set the BIOS in POS terminal 101 and the reduction in process quantity is economical and convenient. In addition, human setting errors can be avoided. It is consequently possible to provide a POS system with high reliability that can prohibit system malfunctioning.

Since motherboard 102, without modification, can be commonly used in POS terminals 101 of various types differing in hardware and/or software configuration even if these POS terminals have different BIOS settings exemplified by a condition for monitoring abnormality on hardware caused by the temperature, voltage and others, management labor and the maintenance cost for parts of motherboard 102 can be reduced, thereby greatly enhancing economy and convenience.

Since the same motherboard 102 can be used in a number of different POS terminals 101 (i.e. of various different types), improvement in usage of the same materials and parts in such different terminals can enhance further economy.

### (B) Modification

Next, description will now be made in relation to a modification of motherboard 102 according to the above first embodiment which is subjected to a modification of settings of the display in POS terminal 101.

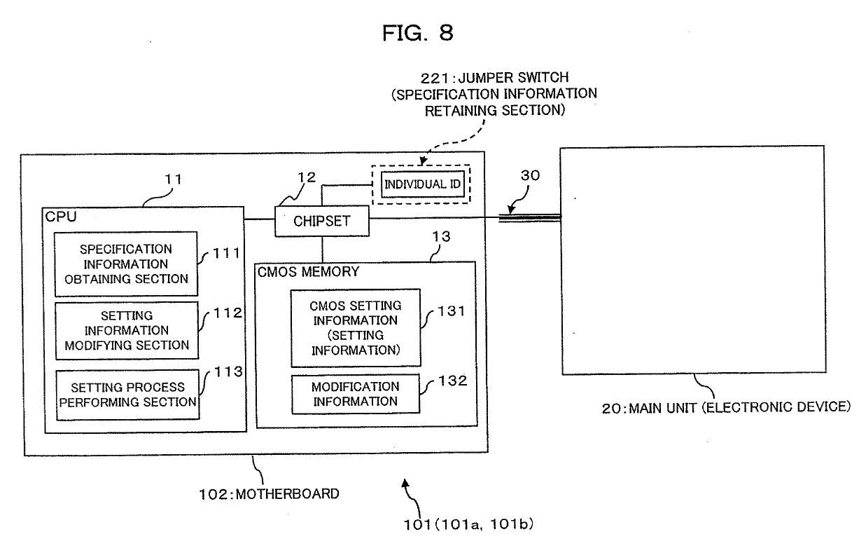

FIG. 8 is a block diagram schematically showing POS terminal 101 in which motherboard 102 according to the modification is installed.

Like reference numbers designate similar parts or elements throughout several views of different illustrated examples, so any repetitious description is omitted here.

In this modification, jumper switch 221 is arranged on motherboard 102 and serves to function as specification information retaining section for retaining an individual ID (specification information) with which the type of POS terminal 101 can be specified.

The operator or the like sets jumper switch 221 arranged on motherboard 102 to conform to the type of POS terminal 101 and installs motherboard 102 to the main unit of the same POS terminal 101.

Specifically, jumper switch 221 includes at least three signal pins (hereinafter, called a first pin, a second pin and a third pin). When motherboard 102 is to be installed in integral-type POS terminal 101a shown in FIG. 2, the first and the second pins are connected (“1-2 short”) on jumper switch 211; and when motherboard 102 is to be installed in separated-type POS terminal 101b shown in FIGS. 3 and 4, the second and the third pins are connected (“2-3 short”) on jumper switch 221.

In this modification, jumper switch 221 arranged on motherboard 102 can be any known type, and a setting value of jumper switch 221 can be obtained by the functions of chipset 12 and realized in any possible method known to the public.

In this modification, whether or not an individual ID set by jumper switch 221 is set to be valid can be arbitrarily set, and further validity/invalidity of an individual ID can beset for each individual item of the CMOS setting information.

For example, various values previously defined are set in predetermined positions in CMOS memory 13 and on the basis of these values, validity/invalidity of an individual ID can be set for each individual item.

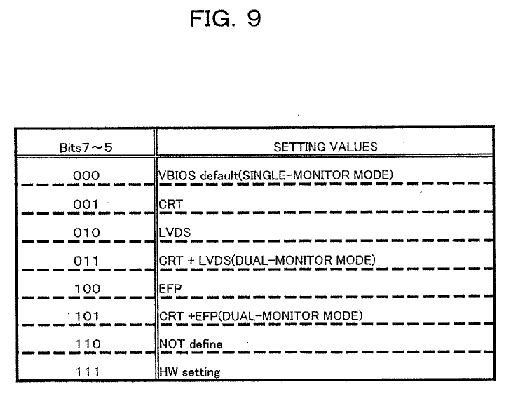

FIG. 9 shows an example of CMOS setting information concerning the boot display in a POS terminal incorporating the motherboard according to the modification of the first embodiment.

In the example shown in FIG. 9, bits 7-5 of 0x41 in CMOS memory 13 concern various settings of the boot display, and the individual ID for the boot display is set to be valid only when the region of bits 7-5 of 0x41 is 0x11.

In this modification, CMOS memory 13 (the region of bits 7-5 of 0x41) function as a setting section for setting whether or not setting information modifying section 112 modifies the setting information.

Further, description will be made in relation to an example in which various settings of the boot display, as one item of CMOS setting information, are set in bits 7-5 of 0x41 in CMOS memory 13. Whether or not setting information for another item (a setting item exemplified by a setting for the input device) of the CMOS setting information is to be modified in another region (e.g., bits 7-5 of 0x42) of CMOS memory 13, i.e., whether or not the individual ID for the other item is set to be valid, may be set. The setting section may set whether or not each individual item of CMOS setting information is to be modified.

In this description, “0x” is a prefix to indicate a hexadecimal number and addition the prefix to the beginning of an integer literal assumes that the integer literal is a hexadecimal number.

The example shown in FIG. 9 indicates that a bit string formed by bits 7-5 of 0x41 in CMOS memory 13 being “000” sets “VBIOS default (the initial setting value of VBIOS); the bit string “001” sets “CRT”; the bit string “010” sets “LVDS”; the bit string “011” sets CRT+LVDS; the bit string “100” sets “EFP”; the bit string “101” sets “CRT+EFP”; and the bit string “111” sets “HW setting”. For the bit string formed by bits 7-5 of 0x41 in CMOS memory 13 being “110”, nothing is defined (NOT define).

“HW setting” that is set for a bit string formed by bit string 7-5 of 0x41 in CMOS memory 13 being “111” indicates that individual ID set by jumper switch 221 is valid and that, on the basis of the individual ID and modification information 132, setting information modifying section 112 modifies CMOS setting information 131. In other words, the bit string indicates that automatic modification on CMOS setting information 131 on the basis of an individual ID is to be performed (is valid).

Hereinafter, description will be made in relation to the case where two BIOS setting items of “CPU FAN alarm” and “PSU FAN alarm” in the CMOS setting and the setting (VBIOS setting) of VBIOS (Video BIOS) are to be modified according to the type (individual ID) of POS terminal 101 in this modification.

Here, the item “CPU FAN alarm” is information about a process performed when an abnormality in CPU fan 105-2 is detected. Specifically, in the event of detection of an abnormality in separated-type POS terminal 101b, the system is shut down. Since integral-type POS terminal 101a does not have CPU fan 105-2, the item “CPU FAN alarm” is set to be “invalid” (Disabled).

The item “PSU FAN alarm” is information indicating a controlling method for power-source fan 105-1. The item set to “Pattern#1” represents control over power-source fan 105-1 on the basis of detection results by temperature sensors 104-1 and 104-2 respectively for CPU 11 and power-source unit 103; and the item set to “Pattern#2” represents control over power-source fan 105-1 on the basis of results detected by temperature sensor 104-2 for power-source unit 103.

“VBIOS setting” represents a setting of the boot display and is exemplified by either “single-monitor mode” or “dual-monitor mode” as a result of a selection.

FIG. 10 shows an example of modification information 132 for POS terminal 101 incorporating motherboard 102 of the modification, and specifically shows an example of settings of BIOS setting items of CMOS memory 13 when an individual ID is set to be valid.

In the example shown in FIG. 10 that assumes that an individual ID is valid, if the first and the second pins are connected (i.e., integral-type POS terminal 101a), the item “CPU FAN alarm” is set to “Disable” and the item “PSU FAN alarm” is set to “Pattern#1” in the CMOS setting information; and if the second and the third pins are connected (i.e., separated-type POS terminal 101b), the item “CPU FAN alarm” is set to “Shutdown” and the item “PSU FAN alarm” is set to “Pattern#2”.

FIG. 11 shows an example of modification information 132 for POS terminal 101 incorporating a motherboard of the modification, and specifically shows an example of setting of VBIOS settings of CMOS memory 13 when an individual ID is set to valid.

In the example shown in FIG. 11 that assumes that an individual ID is valid, if the first and the second pins are connected (i.e., integral-type POS terminal 101a), the VBIOS setting is set to “dual-monitor mode”; and if the second and the third pins are connected (i.e., separated-type POS terminal 11b), VBIOS setting is set to “single-monitor mode”.

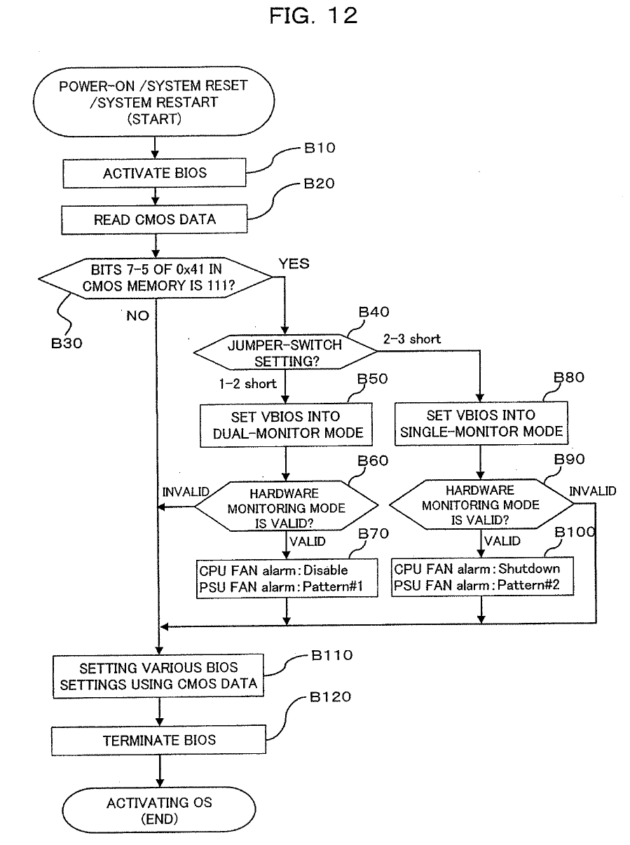

Description will be made in relation to the succession of procedural steps performed when turning on a POS terminal incorporating a motherboard according to the modification with reference to flow diagram FIG. 12 (steps B10-B120).

When POS terminal 101 undergoes powering-on, system reset or system restart, the BIOS program is executed and activated (step B10) and various data pieces (CMOS data) required for activation of POS terminal 101 are read from CMOS memory 13 (step B20).

CPU 11 confirms whether or not the bit string formed by bits 7-5 of 0x41 in CMOS memory 13 is “111” (step B30, the confirmation step). If the result of the confirmation is positive (YES route in step B30), CPU 11 judges that an automatic modification process on CMOS setting information 131 on the basis the individual ID is set to be valid, so that specification information obtaining section 111 confirms the setting of jumper switch 221 (step B40, the specification information obtaining step).

If the first and the second pins of jumper switch 221 are connected (“1-2 short” route in step B40), setting information modifying section 112 judges that motherboard 102 in question is installed to integral-type POS terminal 101a and consequently sets the “VBIOS setting” in CMOS setting information 131 to the “dual-monitor mode” in accordance with modification information 132 (step B50, the setting information modification step). Here, the item “HW setting” in CMOS setting information 131 is maintained and is not modified.

CPU 11 confirms whether or not the hardware monitoring mode is set to be valid (step B60). If the result of the confirmation is positive (“VALID” route in step B60), setting information modifying section 112 sets the item “CPU FAN alarm” to “Disable” and the item “PSU FAN alarm” to “Pattern#1” in CMOS setting information 131 with reference to modification information 132 (step B70, the setting information modification step).

After that, setting process performing section 113 sets various BIOS functions using CMOS setting information 131 modified by setting information modifying section 112 (step B110, the setting process performing step). After completion of the process performed by the BIOS program (step B120), activation of the OS and various programs terminates the activating process and various functions of POS terminal 101 are then realized.

If the second and the third pins of jumper switch 221 are connected (“2-3 short” route in step B40), setting information modifying section 112 judges that motherboard 102 in question is installed in separated-type POS terminal 101b and consequently sets the “VBIOS setting” in CMOS setting information 131 to the “single-monitor mode” in accordance with modification information 132 (step B80, the setting information modification step). Here, the item “HW setting” in CMOS setting information 131 is maintained and is not modified.

CPU 11 confirms whether or not the hardware monitoring mode is set to be valid (step B90). If the result of the confirmation is positive (“valid” route in step B90), setting information modifying section 112 sets the item “CPU FAN alarm” to “Shutdown” and the item “PSU FAN alarm” to “Pattern#2” in CMOS setting information 131 with reference to modification information 132 in the BIOS setting information (step B100, the setting information modification step). Then the procedure shifts to step B110.

On the other hand, if the result of the confirmation in step B30 is negative (NO route in step B30) or if the result of the confirmation in steps B60 or B90 is negative (“INVALID” routes in steps B60 or B90), CMOS setting information 131 is not further modified and the procedure shifts to step B110.

As described above, POS terminal 101 incorporating motherboard 102 of the modification to the first embodiment ensures the same advantages as those of the foregoing first embodiment. In addition, this modification sets various settings concerning the boot display in a predetermined region (e.g., bits 7-5 of 0x41) in CMOS memory 13 and, only when the bit string formed by bits 7-5 of 0x41 is 0x11, sets an automatic modification process on CMOS setting information 131 on the basis of the individual ID to be valid. Accordingly, whether or not CMOS setting information 131 is automatically modified can be arbitrarily set in this modification, which is therefore high in flexibility.

Further, since validity/invalidity of an individual ID can be set for each item of CMOS setting information 131, the modification provides high flexibility and high convenience.

### (C) Others

Further, the present invention should by no means be limited to the foregoing embodiment and modification, and various changes or modification may be suggested without departing from the gist of the invention.

In the above embodiment, modification information 132 includes setting values after modification of only BIOS setting items that vary with types of a number of POS terminals, and setting information modifying section 112 modifies part of the BIOS setting items in CMOS setting information 131 according to the type of POS terminal 101, to which the present invention should by no means be limited. Alternatively, all the BIOS setting items of the BIOS setting information for each type of POS terminals may be prepared as CMOS setting information 131, and setting information modifying section 112 may modify the entire CMOS setting information 131 in accordance with the type of POS terminal 101. Various modification manners can be suggested without departing the concept of the present invention.

Further, individual ID setting section 21 installed in main unit 20 of the first embodiment takes the form of an individual ID fixed to a print board, but should by no means be limited to this. Alternatively, individual ID setting section 21 may be formed by a device such as a DIP switchpack that is able to vary setting values whereby an individual ID can be modified. That makes the system more flexible.

Similarly, individual ID setting section 21 installed in motherboard 102 may also be formed by a device such as a DIP switchpack that is able to vary setting values whereby an individual ID can be modified. That also makes the system more flexible.

In the above modification, an individual ID is set to be valid only when a value set in a predetermined position (bits 7-5 of 0x41) in CMOS memory 13 is 0x11, to which the present invention should not be however limited.

Alternatively, a setting indicating whether or not an individual ID is valid may be stored in a position other than 0x41 in CMOS memory 13, and a setting value other than 0x11 may represent that an individual ID is valid.

A setting indicating whether or not an individual ID is valid is realized not only by means of software as in the foregoing embodiment and modification but also alternatively by means of hardware of a switch such as a jumper switch or a DIP switchpack.

In the modification, an individual ID is set by jumper switch 221 installed on motherboard 102, to which the present invention is limited and which can be substituted by any other switch.

Motherboard 102 of the first embodiment and the modification is commonly used by two types of POS terminals 101a and 101b. But, the motherboard should by no means be limited to this usage and alternatively may be commonly used in POS terminals 101 of three types or more.

Use of motherboard 102 in POS terminals 101 of three types or more can be realized by increasing the number of bits of an individual ID.

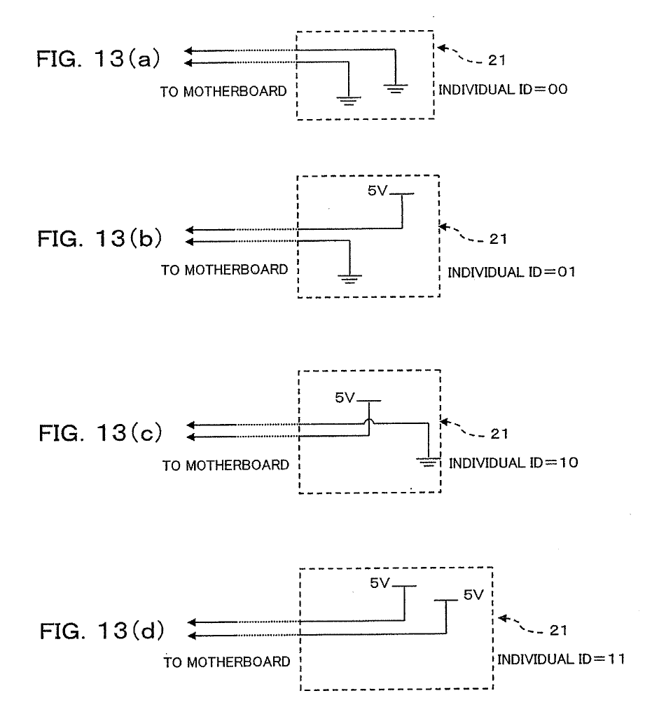

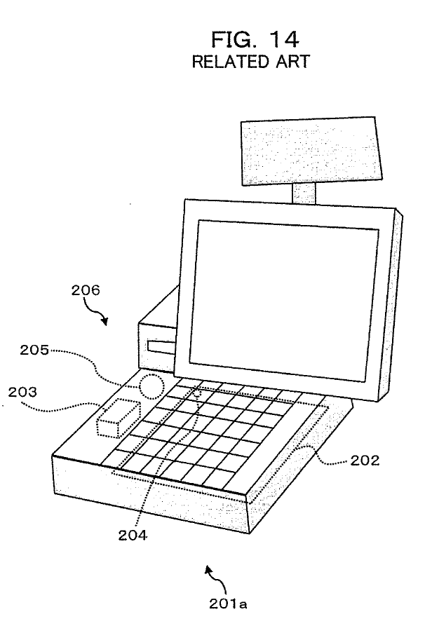

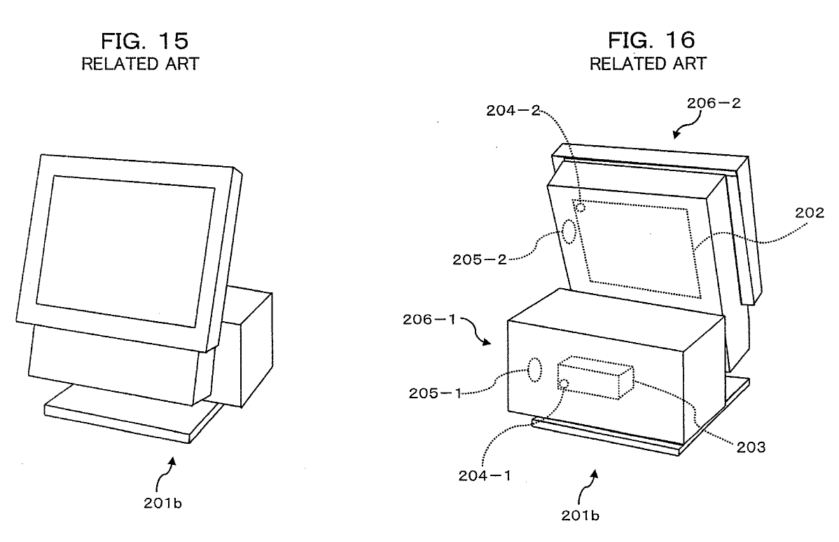

FIGS. 13(a), (b), (c) and (d) are other examples of individual ID setting section 21 in POS terminal 101 in which motherboard 102 of the first embodiment is installed. Each of individual ID setting sections 21 shown in FIGS. 13 (a), (b), (c) and (d) include two terminals (two bits). Connecting one terminal to the ground and the other to the power source, and connecting both terminals to the ground or to the power source can represent four digits “01”, “10”, “11”, and “00” to individual ID setting sections 21, which are to be associated one with each of four types of POS terminals.

As described above, increments in bit number in individual ID setting section 21 can make it possible for the present invention to apply to any number of types of POS terminal.

In the above embodiment and modification, motherboard 102 is connected to main unit 20 of POS terminal 101, which is to be set. But the present invention is not limited to this. Alternatively, a POS terminal 101 serving as the setting object may be substituted by an electronic device such as an LCD (Liquid Crystal Display), a keyboard, or a printer. The present invention may set these electronic devices when being connected to motherboard 102.

In this alternative, an operator does not have to perform a setting process for connection of such an electronic device to a motherboard, so the process is simplified and becomes economical and convenient. In addition, human setting errors can be avoided. It is consequently possible to provide a POS system with high reliability in which system malfunctions are prohibited.

Further, connection between motherboard 102 and these electronic devices via a USB (Universal Serial Bus) makes it possible for motherboard 102 (setting information modifying section 112) to easily obtain individual IDs which have been set in these electronic devices in any manner.

The description of the present invention is made of a function for controlling a power-source fan rotation speed which function concerns temperature control in the first embodiment and on the boot display in the modification. The present invention is not limited to such control, and can be applied to any function and setting (CMOS setting) for information processors.

What is claimed is:

1. A motherboard capable of being installed in each of a plurality of electronic devices of various types different in configuration comprising:
a setting information retaining section retaining setting information that is to be used in a setting process for each of said plurality of electronic devices;
a specification information obtaining section obtaining specification information that is to be used for specifying the type of each said electronic device;
a modifying information retaining section retaining modification information that is to be used for modifying the setting information according to said type of each said electronic device;
a setting information modifying section modifying, on the basis of the specification information obtained by said specification information obtaining section and the modification information retained in said modifying information retaining section, the setting information retained in said setting information retaining section according to said type of each said electronic device in which said motherboard is installed; and
a setting process performing section for performing the setting process for one of said plurality of electronic devices in which said motherboard is installed on the basis of said setting information modified by setting information modifying section.

2. A motherboard according to claim 1, wherein:
each said electronic device includes a specification information retaining section retaining the specification information; and
said specification information obtaining section obtains the specification information from said one electronic device in a state in which said mother board is installed.

3. A motherboard according to claim 1, further comprising a specification information retaining section retaining the specification information, said specification information obtaining section obtaining the specification information from the specification information retaining section.

4. A motherboard according to claim 1, further comprising a setting section setting whether or not said setting information modifying section is to modify the setting information, said setting information modifying section modifying the setting information only when the result of setting by said setting section is positive.

5. A motherboard according to claim 4, wherein said setting section sets whether or not said setting information modifying section is to perform the modifying for each item of the setting information.

6. An information processor including a main unit and a motherboard, which is capable of being installed in said main unit and which is capable of being installed in a main unit of an information processor of another type different in configuration from said first information processor, comprising:
a specification information retaining section retaining specification information that is to be used for specifying the type of said first information processor;
a setting information retaining section retaining setting information that is used in a setting process for said first information processor;
a specification information obtaining section obtaining the specification information from said specification information retaining section in a state in which said motherboard is installed in said main unit of said first information processor;
a modifying information retaining section retaining modification information that is to be used for modifying the setting information according to said type of each said electronic device;
a setting information modifying section modifying, on the basis of the specification information obtained by said specification information obtaining section and the modification information retained in said modifying information retaining section, the setting information retained in said setting information retaining section according to said type of said first information processor in which said motherboard is installed; and
a setting process performing section for setting the setting process for said first information processor on the basis of said setting information modified by setting information modifying section, wherein
said motherboard includes said setting information retaining section, said specification information obtaining section, said modification information retaining section, said setting information modifying section and said setting process performing section.

7. An information processor according to claim 6, wherein said main unit of said first processor includes said specification information retaining section.

8. An information processor according to claim 7, wherein said specification information obtaining section obtains the specification information from said main unit of said first processor in a state in which said motherboard is installed in said main unit.

9. An information processor according to claim 6, wherein said motherboard includes said specification information retaining section.

10. An information processor according to claim 9, wherein said specification information obtaining section obtains the specification information from said specification information retaining section.

11. An information processor according to claim 6, further comprising a setting section setting whether or not said setting information modifying section is to modify the setting information, said setting information modifying section modifying the setting information only when the result of setting by said setting section is positive.

12. An information processor according to claim 6, wherein said setting section sets whether or not said setting information modifying section is to perform the modifying for each item of the setting information.

13. A method for setting an information processor including a main unit and a motherboard, which is capable of being installed in said main unit and which is capable of being installed in main units of a number of second information processors of various types different in configuration from said first information processor, comprising the steps of:
obtaining specification information that is to be used for specifying the type of the first information processor;
modifying, on the basis of the specification information obtained in said step of obtaining and modification information used for modifying setting information used in a setting process for setting the first information processor according to the type of the first information processor which setting information is retained in a setting information retaining section, the setting information according to the type of the first information processor in which the motherboard is installed; and
performing the setting process on the first information processor using the setting information modified in said step of modifying.

14. A method for setting an information processor according to claim 13, further comprising the step of confirming whether or not the setting information is to be modified in said step of modifying, wherein
the setting information is modified in said step of modifying only when the result of the confirming in said step of confirming is positive.

15. A method for setting an information processor according to claim 14, wherein, in said step of setting, whether or not the modifying in said step of modifying is to be performed is set for each item of the setting information.

16. A computer-readable recording medium in which a setting program for setting a computer including a main unit and a motherboard, which is capable of being installed in said main unit and which is capable of being installed in a number of computers of various types different in configuration from the first computer is recorded, wherein said setting program instructs the first computer to execute the following steps of:
obtaining specification information that is to be used for specifying the type of the first computer;
modifying, on the basis of the specification information obtained in said step of obtaining and modification information used for modifying setting information used in a setting process for the first computer according to the type of the first computer which setting information is retained in a setting information retaining section, the setting information according to the type of the first computer in which the motherboard is installed; and
performing the setting process on the first computer using the setting information modified in said step of modifying.

17. A recording-medium according to claim 16, wherein:
said setting program further instructs the first computer to execute the step of confirming whether or not the setting information is to be modified in said step of modifying;
the modifying of the setting information in said step of modifying is performed only when the result of the confirming in said step of confirming is positive.

18. A recording-medium according to claim 17, wherein, in said step of setting, whether or not the modifying in said step of modifying is to be performed is set for each item of the setting information.
